(19) United States
(12) Patent Application Publication
(10) Pub. No.: US 2024/0238902 A1
(43) Pub. Date: Jul. 18, 2024

(54) BATTERY MODULE HAVING WELDING AREA WITH ENHANCED SURFACE ROUGHNESS

(71) Applicant: SK On Co., Ltd., Seoul (KR)

(72) Inventors: Hoemin CHEONG, Daejeon (KR); Hyeong Won KIM, Daejeon (KR); Sung Chel YOON, Daejeon (KR); Ki Dong LEE, Daejeon (KR); Ji Hun KIM, Daejeon (KR); Hyeon Jeong YOU, Daejeon (KR)

(21) Appl. No.: 18/411,583

(22) Filed: Jan. 12, 2024

(30) Foreign Application Priority Data
Jan. 13, 2023 (KR) 10-2023-0005202

(51) Int. Cl. B23K 26/26; B23K 101/36; B23K 103/10; H01M 50/119

(52) U.S. Cl. CPC B23K 26/26; H01M 50/119; B23K 2101/36; B23K 2103/10

(57) ABSTRACT

Provided is a battery module including: A battery module comprising: a plurality of battery cells; a housing accommodating the plurality of battery cells therein, wherein the housing includes a first base material member and a second base material member, the first base material member and the second base material member are in contact with each other to form a joining region, a weld joint is formed in the joining region by welding, and a surface treatment region is formed in the joining region by laser emission, thus increasing an accuracy of a welding position between the base materials, which results in an increased welding process ability and an improved welding quality of the module.

### CROSS-REFERENCE TO RELATED APPLICATIONS

This application claims priority under 35 U.S.C. § 119 to Korean Patent Application No. 10-2023-0005202, filed on Jan. 13, 2023, the disclosure of which is incorporated herein by reference in its entirety.

### TECHNICAL FIELD

Embodiments of the present disclosure relates to a battery module accommodating a plurality of battery cells.

### BACKGROUND

A battery module may include a housing forming an accommodation space and a plurality of battery cells packed inside the accommodation space. The housing may also provide an accommodation space for any sealing materials and/or components used for sealing the inside of the housing and also for assembling and operatively connecting the battery cells. For example, the housing may have a joint structure comprising two housing members welded to each other. In the accommodation space, pouch-shaped or square-shaped battery cells may be packed and electrically connected in series and/or in parallel to each other.

Oftentimes, for example, during use of the battery module, the housing of the battery module may receive an impact from the outside which may damage the welded connection holding together the housing members which make up the housing. The damage may risk leaking harmful materials from the battery cells which are inside the accommodation space of the housing. The housing is also subject to the risk fatigue damage caused by repeated loading due to repeated charging/discharging, vibration, or the like.

A material used for the housing members may include metal alloys such as an aluminum alloy. The housing members may be mainly produced by extrusion and rolling processing methods. A surface of the housing member may be mainly processed by a milling processing method. The housing member may have a grain pattern on its surface in a processing direction by using the extrusion and rolling processing methods. The milling processing method may produce an arbitrary pattern on the surface of the housing member or a product surface with a variation in lightness for each material. In addition, a defect such as a scratch may occur on the surface in the subsequent processing or logistics of each material.

The welding of the housing members to form the housing may be performed through an automated process using an auto position alignment (APA) function. The APA function may be affected by the pattern formed on the surface of the housing member by the extrusion, rolling, or milling method, a scratch caused by an external factor, or the like.

In particular, when different processing methods are applied to the housing members in contact with each other and welded to each other, the patterns formed on their surfaces may be different from each other. These different patterns may lower an accuracy of the APA function. A welding laser may weld an inappropriate area. The inappropriate welding may lower a mechanical rigidity of the housing.

Korean Patent No. 10-2241333 registered on Apr. 16, 2021 describes a battery module for a secondary battery.

### SUMMARY

An embodiment of the present disclosure is directed to providing a battery module having a lower defect rate in its fabrication process, and having sufficient mechanical rigidity and strength, by securing an accuracy of a welding position of a secondary cell battery module, and a fabrication method thereof.

In one general aspect, provided is a battery module including: a plurality of battery cells; a housing accommodating the plurality of battery cells therein, wherein the housing includes a first base material and a second base material, the first base material and the second base material are in contact with each other to form a joining region, a weld joint is formed in the joining region by welding, and a surface treatment region is formed in the joining region by laser emission.

The weld joint may include a weld bead formed by melting and solidifying the first base material and the second base material, and the weld bead may cover the surface treatment region or expose a portion of the surface treatment region.

A step difference between the surface treatment region and the surface of the first or second base material may be 200 μm or less.

Lightness L_{T} of the surface treatment region and lightness Lₘ of the surface of the first or second base material may have a relationship of L_{T}≤0.7 Lₘ or L_{T}≥1.2 Lₘ.

The weld joint may be any one of a butt joint, a corner joint, a flanged edge joint, and a tee joint.

Each of the first base material and the second base material may be an aluminum alloy.

Each of the first base material and the second base material may have a shape of a square plate or a square plate with one end or both ends bent vertically.

In another general aspect, provided is a fabrication method of a battery module by welding a first base material and a second base material to each other, the first and second base materials being included in a housing which accommodates a plurality of battery cells therein, the method including: step (a) of inputting and aligning a first base material and a second base material; a step (b) of performing a surface treatment by emitting a laser to a surface region including a joining region formed by contacting the first base material and the second base material with each other; and a step (c) of forming a weld joint by emitting the laser to the joining region.

The step (b) may include: a step (b-1) of forming the surface region that includes a surface of the first base material disposed on one side of the joining region and a surface of the second base material disposed on the other side of the joining region, based on the joining region; and a step (b-2) of forming a surface treatment region by emitting the laser to the surface region.

In the step (c), the weld joint may include a weld bead formed by melting and solidifying the first base material and the second base material.

In the step (c), the weld bead may cover the surface treatment region or expose a portion of the surface treatment region.

The laser may be a near-infrared laser.

### BRIEF DESCRIPTION OF THE DRAWINGS

FIG. 1 is an exploded perspective view of a module in connection with a fabrication method of a battery module according to an embodiment of the present disclosure.

FIGS. 2 to 4 are schematic views of a first base material and a second base material viewed from the top in connection with the fabrication method of a battery module according to an embodiment of the present disclosure.

FIGS. 5 and 6 are schematic views of the first base material and the second base material viewed from the side in connection with the fabrication method of a battery module according to an embodiment of the present disclosure.

FIG. 7 is a view showing a surface treatment by a laser in connection with the fabrication method of a battery module according to an embodiment of the present disclosure.

FIG. 8 is a view schematically showing that a weld bead exposes a portion of a surface treatment region.

FIG. 9 is a view schematically showing that the weld bead covers a portion of the surface treatment region.

FIG. 10 is a view showing a region “B” of FIG. 7 that is captured by a vision camera.

FIG. 11 is a graph showing the surface treatment and welding process by the laser over time.

### DETAILED DESCRIPTION OF EMBODIMENTS

Hereinafter, specific embodiments of the present disclosure are described in detail with reference to the drawings.

Further, in describing the embodiments of the present disclosure, omitted is a detailed description of a case where it is decided that the detailed description of the known function or configuration related to the present disclosure may unnecessarily obscure the gist of the present disclosure.

The present invention is described herein with reference to cross-section and/or plan illustrations of embodiments of the present disclosure. However, embodiments of the present disclosure should not be construed as limiting the inventive concept. Although a few embodiments of the present disclosure will be shown and described, it will be appreciated by those of ordinary skill in the art that changes may be made in these embodiments without departing from the principles and spirit of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. Furthermore, the connection/coupling may not be limited to a physical connection but may also include a non-physical connection, e.g., a wireless connection.

In addition, it will also be understood that when an element is referred to as being “between” two elements, it may be the only element between the two elements, or one or more intervening elements may also be present.

When a first element is referred to as being “over” a second element, it not only refers to a case where the first element is formed directly on the second element but also a case where a third element exists between the first element and the second element. When a first element is referred to as being “on” a second element, it refers to a case where the first element is formed directly on the second layer or the substrate.

It should be understood that the drawings are simplified schematic illustrations of the described devices and may not include well known details for avoiding obscuring the features of the invention.

It should also be noted that features present in one embodiment may be used with one or more features of another embodiment without departing from the scope of the invention.

It is further noted, that in the various drawings, like reference numbers designate like elements.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure.

It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

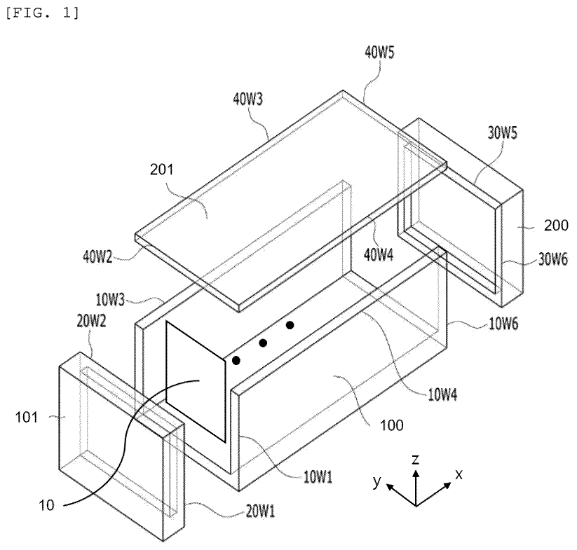

Referring now to FIG. 1, a battery module may include a housing 1000 accommodating a plurality of battery cells 10 therein. The housing 1000 may include a plurality of base material members 100, 101, 200, and 201. The plurality of base material members 100, 101, 200, and 201. may be joined to each other by welding, e.g., by using a laser.

Each of the plurality of base material members 100, 101, 200, and 201. may be made of an aluminum alloy. In addition, the plurality of base material members 100, 101, 200, and 201. may respectively be made using different molding methods. The plurality of base material members 100, 101, 200, and 201. may respectively have different patterns on their surfaces based on the molding methods. For example, the lower base material member 100 may be molded by extrusion, and have a pattern in an extrusion direction. The side base material member 101 or 200 may be molded by die casting, and have a specific pattern on its surface through post-processing by milling. The upper base material member 201 may be molded by a press after rolling, and have a pattern in a rolling direction and an irregular pattern produced by the press. In addition, the base material members 100, 101, 200, and 201 may commonly have scratches of 0.3 mm or more on their surfaces formed in a transportation process.

The plurality of base material members 100, 101, 200, and 201 may be disposed as shown in FIG. 1 to form the case. The base material members 100, 101, 200, and 201 may be joined to each other by welding. A welding position may have two lines in an x-axis direction (in FIG. 1, the same hereinafter) in which the lower base material member 100 and the upper base material member 201 are in contact with each other, four lines in a z-axis direction and two lines in a y-axis direction, in which the lower base material member 100 and the side base material members 101 and 200 are in contact with each other, and two lines in the y-axis direction in which the upper base material member 201 and the side base material members 101 and 200 are in contact with each other.

As described above, each of the base material members 100, 101, 200, and 201 may have the pattern formed on its surface by the molding method. This pattern may affect a welding process using an auto position alignment (APA) function. That is, the pattern may cause an error in recognizing the welding position by the APA function.

The fabrication method of a battery module case according to an embodiment of the present disclosure may increase an accuracy of the welding position by eliminating this error.

The fabrication method of a battery module according to an embodiment of the present disclosure may include: operation (a) of inputting and aligning a first base material member 100 and a second base material member 200 included in the housing which accommodates the battery cell therein; a step (b) of performing a surface treatment by emitting the laser to a surface region 320 including a joining region 310 formed by contacting the first base material 100 and the second base material 200 with each other; and a step (c) of forming a weld joint 300 by emitting the laser to the joining region 310. Also, the operation (a) includes inputting a first base material member 100 and a second base material member 200.

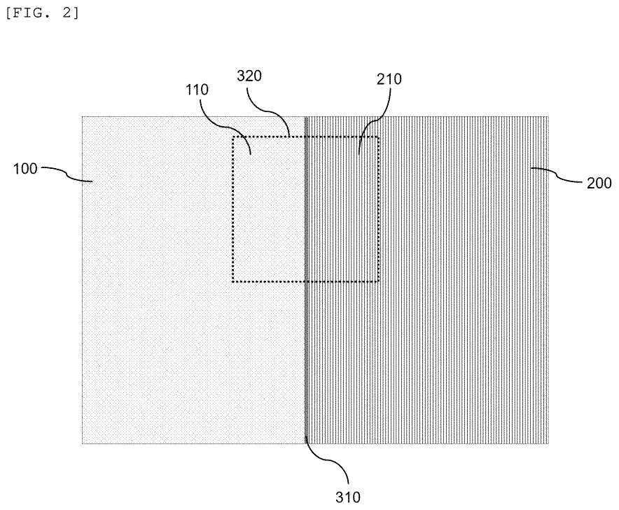

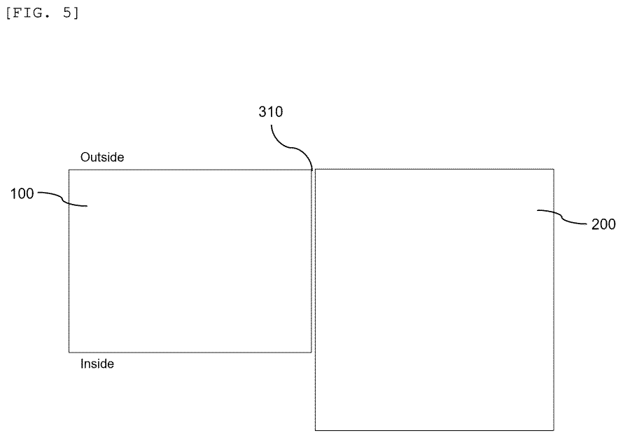

Referring to FIGS. 2 to 5, in the operation (a), the first base material member 100 and the second base material member 200 may be placed on a welding station for the welding. The first base material member 100 and the second base material member 200 may undergo an alignment process to ensure they are in contact with each other in order to form the joining region 310. (FIG. 5 shows that the first base material member 100 and the second base material member 200 may not overlap with each other.) Here, the first base material member 100 and the second base material member 200 may be welding objects arbitrarily selected from the base material members 10, 20, 30, and 40 described above (the same hereinafter). For example, the first material member 100 may be one of the side base material members 20 and the second base material member 200 may be the upper base material 40.

In the operation (b), a surface treatment region 330 may be formed by emitting the laser to the surface region 320 including the joining region 310. First, the surface region 320 may be formed in an operation (b-1). The surface region 320 may include a surface 110 of the first base material member that is disposed on one side of the joining region 310 and a surface 210 of the second base material member that is disposed on the other side of the joining region 310, based on the joining region 310. In an operation (b-2), the surface treatment region 330 may be formed by emitting the laser to the surface region 320.

By the operation (b), the surface treatment region 330 may include a surface 110-1 of the first base material member that is surface-treated and a surface 210-1 of the second base material that is surface-treated. Here, a pattern of the surface-treated surface 110-1 of the first base material member and a pattern of the surface-treated surface 210-1 of the second base material member may be different from each other due to a difference between the reactivity of the first base material member 100 to the emission of the laser and reactivity of the second base material member 200 to the emission of the laser.

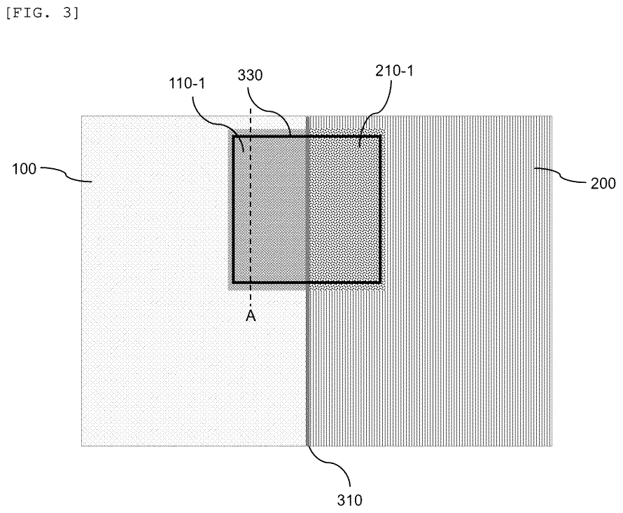

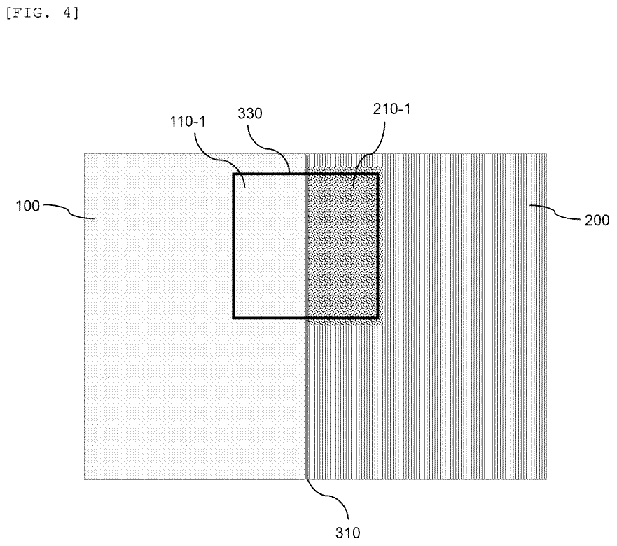

FIG. 3 shows that the reactivity of the first base material member 100 and that of the second base material member 200 to the emission of the laser are different from each other and as a result cause their patterns in the surface treatment region 330 to be different from each other. FIG. 4 shows that there is no difference in the reactivity of the first base material member and the reactivity of the second base material member thus causing their patterns in the surface treatment region 330 to be similar to each other. In any case, the patterns in the surface treatment region 330 may highlight the joining region 310 by clearly distinguishing the first base material member 100 and the second base material member 200 from each other. This configuration may increase a recognition rate in operating the APA function.

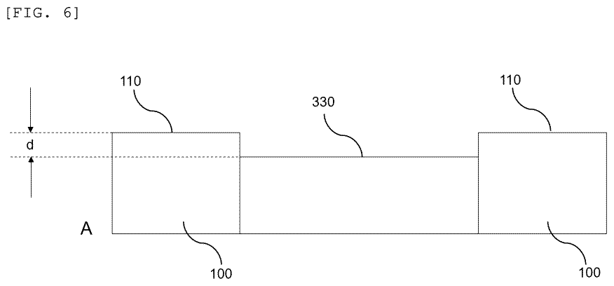

Referring to FIG. 6 together, a step difference “d” between the surface treatment region 330 and the surface 110 or 210 of the first or second base material member may be 200 μm or less. A length of the step difference “d” may be managed to increase the recognition rate for the joining region 310 in operating the APA function.

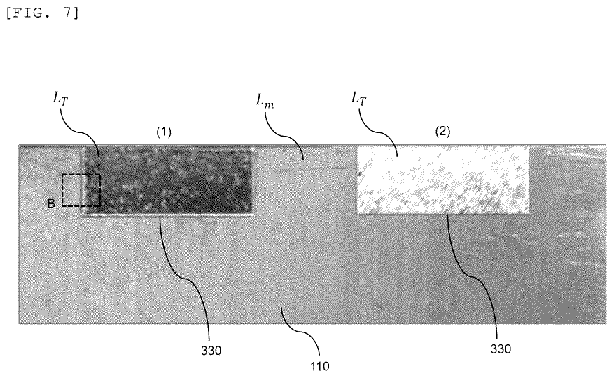

Referring to FIG. 7, when lightness of the surface treatment region 330 is and lightness of the surface 110 or 210 of the first or second base material members is, a relationship between and may be ≤0.7 or ≥1.2.

Each of and represents the lightness of an image captured by a measurement device. and may each have arbitrary numbers and satisfy the relationship described above. Here, a portion (1) of FIG. 7 shows a case where the treatment is performed to have a dark surface, and a portion (2) of FIG. 7 shows a case where the treatment is performed to have a bright surface.

The recognition rate for the joining region 310 in operating the APA function may be increased by managing the lightness between the surface treatment region 330 and the surface 110 of the first base material member or the surface 210 of the second base material member. In addition, as may be seen from FIG. 7, the joining region 310 may be clearly distinguished by removing the pattern formed on the surface 110 of the first base material member or the surface 210 of the second base material member.

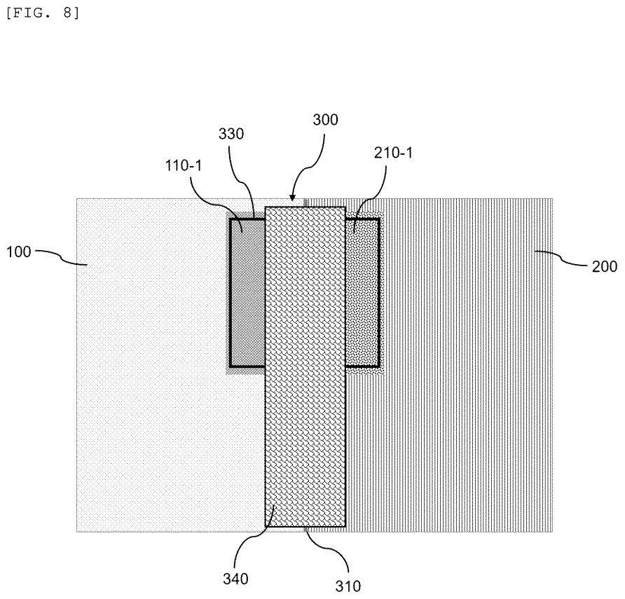

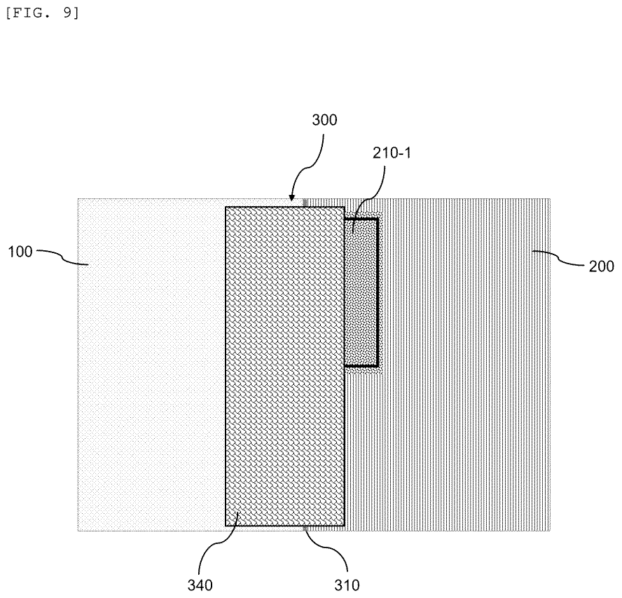

Referring to FIGS. 8 and 9 together, the weld joint 300 may be formed in the joining region 310 when the laser is emitted to the joining region 310 in the operation (c). The surface 110 of the first base material member and the surface 210 of the second base material may be joined to each other by the weld joint 300. More specifically, the surface 110-1 of the first base material member that is surface treated and the surface 210-1 of the second base material may be joined to each other by the weld joint 300. The weld joint 300 may include a weld bead 340 formed in the processes of melting and solidifying the first base material member 100 and the second base material member 200.

Here, an intensity of the laser may be adjusted for the weld bead 340 to cover the surface treatment region 330 or expose a portion of the surface treatment region 330. FIG. 8 shows that the weld bead 340 exposes a portion of the surface treatment region 330 on the first base material member 100, and FIG. 9 shows that the weld bead 340 covers a portion of the surface treatment region 330 on the second base material member 200. The surface treatment region 330 may be exposed to provide focus on quality control such as defect detection.

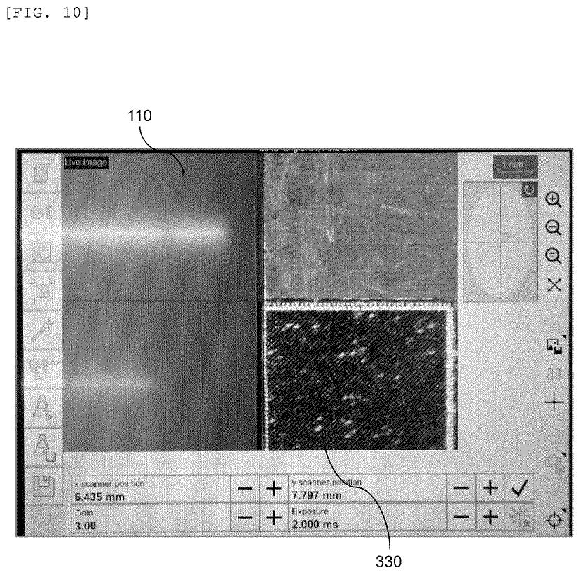

FIG. 10 shows a region “B” of FIG. 7 that is captured by a vision camera. Referring to FIG. 10, it may be seen that the surface 110 of the first base material member and the surface treatment region 330 are clearly distinguished from each other on the first base material member 100. It may be seen that a pattern and color of the surface 110 of the first base material member and a pattern and color of the surface treatment region 330 are different each other.

The fabrication method of a battery module case according to an embodiment of the present disclosure may be performed by a laser welding system including a laser output device emitting the laser, the welding station seating the first base material member and the second base material thereon, the vision camera capturing the surfaces of the first base material member and the second base material, and the like. However, the above configuration is known in a technical field of the present disclosure, and the description thus omits a detailed description thereof.

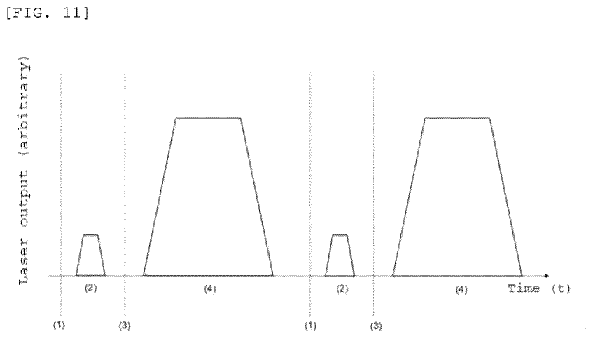

FIG. 11 shows the surface treatment and welding process by the laser over time and illustrates a continuous flow in the fabrication method of a battery module case according to an embodiment of the present disclosure based on the above-described configuration.

Referring to FIG. 11, in an operation (1), the laser output device may be moved to a position above the surface regions of the first base material member and the second base material member. In an operation (2), the laser may be emitted to the surface region including the joining region of the first base material member and the second base material member to thus form the surface treatment region. In an operation (3), the position alignment function may be operated to recognize the joining region in the surface treatment region. In an operation (4), the welding may be performed with a stronger output than the laser output in the operation (2). The laser output device may then be moved to another position to repeat the operations (1) to (4) again.

The fabrication method of a battery module case according to an embodiment of the present disclosure may enable the welding position to be accurately and quickly recognized in the continuous welding process as above in operating the APA function, thus increasing the welding process ability and improving the welding quality. However, there may be the welding position where the surface treatment processes (1) and (2) are omitted based on a property of the material.

In addition, a battery module according to another embodiment of the present disclosure may be manufactured using the fabrication method of a battery module case according to an embodiment of the present disclosure, and may have all features of the fabrication method of a battery module according to an embodiment of the present disclosure described above.

In addition, the battery module according to another embodiment of the present disclosure may include a housing accommodating a battery cell therein. The housing may include a first base material 100 and a second base material 200. The first base material 100 and the second base material 200 may be in contact with each other to form a joining region 310. A weld joint 300 may be formed in the joining region 310 by welding. A surface treatment region 330 may be formed in the joining region 310 by laser emission.

Here, the weld joint 300 may be any one of a butt joint, a corner joint, a flanged edge joint, and a tee joint. However, a butt joint method may be mainly applied to the weld joint 300.

As set forth above, the fabrication method of a battery module according to the present disclosure may increase the recognition rate in operating the auto position alignment (APA) function regardless of the surface condition of the base material included in the battery module.

In addition, the method according to the present disclosure may increase the recognition rate in operating the APA function, thereby increasing the accuracy of the welding position between the base materials, which results in the increased welding process ability and the improved welding quality of the module.

The embodiments of the present disclosure have been described above for illustrative purposes, and those skilled in the art to which the present disclosure pertains will appreciate that various modification and other equivalent embodiments are possible therefrom. Therefore, those skilled in the art will fully understand that the present disclosure is not limited to the specific embodiments described in the detailed description above. Accordingly, an actual technical scope of the present disclosure is to be defined by a technical spirit of the appended claims. In addition, it is to be understood that the present disclosure includes all modifications, equivalents, and substitutes within the spirit and scope of the present disclosure as defined by the appended claims.

What is claimed is:

1. A battery module comprising:
a plurality of battery cells; and
a housing accommodating the plurality of battery cells therein,
wherein the housing includes a first base material member and a second base material member, the first base material member and the second base material member are in contact with each other to form a joining region, a weld joint is formed in the joining region by welding, and a surface treatment region is formed in the joining region by laser emission.

2. The battery module of claim 1, wherein the weld joint includes a weld bead formed by melting and solidifying the first base material member and the second base material member, and
the weld bead covers the surface treatment region or exposes a portion of the surface treatment region.

3. The battery module of claim 1, wherein a step difference between the surface treatment region and the surface of the first or second base material member is 200 μm or less.

4. The battery module of claim 1, wherein lightness L_{T} of the surface treatment region and lightness Lₘ of the surface of the first or second base material members have a relationship of L_{T}≤0.7 Lₘ or L_{T}≥1.2 Lₘ.

5. The battery module of claim 1, wherein the weld joint is one of a butt joint, a corner joint, a flanged edge joint, and a tee joint.

6. The battery module of claim 1, wherein each of the first base material member and the second base material member is an aluminum alloy.

7. The battery module of claim 6, wherein at least one of the first base material member and the second base material is an aluminum-based alloy containing silicon.

8. The battery module of claim 6, wherein each of the first base material member and the second base material member have a shape of a square plate or a square plate with one end or both ends bent vertically.

9. A fabrication method of a battery module by welding a first base material member and a second base material member to each other, the first and second base materials members being included in a housing which accommodates a plurality of battery cells therein, the method comprising:
an operation (a) of aligning a first base material member and a second base material member among the plurality of the base material members;
an operation (b) of performing a surface treatment by emitting a laser to a surface region including a joining region formed by contacting the first base material member and the second base material with each other; and
an operation (c) of forming a weld joint by emitting the laser to the joining region.

10. The method of claim 9, wherein the operation (b) includes:
an operation (b-1) of forming the surface region that includes a surface of the first base material member disposed on one side of the joining region and a surface of the second base material member disposed on the other side of the joining region, based on the joining region; and
an operation (b-2) of forming a surface treatment region by emitting the laser to the surface region.

11. The method of claim 10, wherein in the operation (c), the weld joint includes a weld bead formed by melting and solidifying the first base material member and the second base material member.

12. The method of claim 11, wherein in the operation (c), the weld bead covers the surface treatment region or exposes a portion of the surface treatment region.

13. The method of claim 9, wherein the laser is a near-infrared laser.
